(19) United States
(12) Patent Application Publication
(10) Pub. No.: US 2015/0177572 A1
(43) Pub. Date: Jun. 25, 2015

(54) LIQUID CRYSTAL DISPLAY DEVICE

(71) Applicant: Sharp Kabushiki Kaisha, Osaka-shi, Osaka (JP)

(72) Inventors: Yuichi Kita, Osaka-shi (JP); Kazuhiko Tsuda, Osaka-shi (JP); Takatomo Yoshioka, Osaka-shi (JP)

(21) Appl. No.: 14/416,321

(22) PCT Filed: Jul. 18, 2013
(86) PCT No.: PCT/JP2013/069458

§ 371 Date: Jan. 22, 2015

(30) Foreign Application Priority Data
Jul. 25, 2012 (JP) 2012-165198

(51) Int. Cl. G02F 1/1343; G02F 1/1368; G02F 1/1333

(52) U.S. Cl. CPC G02F 1/134309; G02F 1/133345; G02F 1/1368

(57) ABSTRACT

The present invention provides a liquid crystal display device that can suppress flicker. The liquid crystal display device of the present invention includes a pair of substrates; and a liquid crystal layer interposed between the pair of substrates, at least one of the pair of substrates including a first electrode that includes at least two parallel comb teeth and at least two parallel slits, a second plate electrode, and an insulating film that separates the first electrode and the second electrode into different layers, assuming that the width of a comb tooth is L1 and the width of another comb tooth is L2 among the at least two comb teeth; and that the width of a slit is S1 and the width of another slit is S2 among the at least two slits, then L1, L2, S1, and S2 satisfy the formulas (H1) to (H6).

### TECHNICAL FIELD

The present invention relates to a liquid crystal display device. More specifically, the present invention relates to a liquid crystal display device which is suitable for an FFS mode display system adopting a drive method in which the polarity of pixel electrodes is inverted frame by frame.

### BACKGROUND ART

Liquid crystal display devices control transmission/shielding of light (ON/OFF of display) by controlling the alignment of birefringent liquid crystal molecules. Exemplary liquid crystal alignment modes of liquid crystal display devices include a twisted nematic (TN) mode in which liquid crystal molecules having positive anisotropy of dielectric constant are aligned with 90° twist when seen in the normal direction of a substrate, a vertical alignment (VA) mode in which liquid crystal molecules having negative anisotropy of dielectric constant are aligned in a direction perpendicular to a substrate surface, and an in-plane switching (IPS) mode and a fringe field switching (FFS) mode in which liquid crystal molecules having positive or negative anisotropy of dielectric constant are aligned in parallel with a substrate surface, and a transverse electric field is applied to a liquid crystal layer.

A popular drive system of liquid crystal display devices is an active-matrix drive system in which an active element such as a thin film transistor (TFT) is provided in each pixel to enable generation of high-definition images. In an array substrate provided with a plurality of TFTs and a plurality of pixel electrodes, a plurality of scanning signal lines and a plurality of data signal lines are formed to cross each other, and the TFTs are disposed at respective intersections. The TFTs are connected to the pixel electrodes and control the supply of an image signal to the pixel electrodes by their switching functions. An array substrate or a counter substrate further includes a common electrode to apply a voltage inside a liquid crystal layer through a pair of electrodes.

An FFS mode is one of systems for controlling the alignment of liquid crystal molecules by applying a transverse electric field, and is a liquid crystal alignment mode achieved by improving an IPS mode to enhance the aperture ratio. In an FFS mode, a pixel electrode includes a plurality of slits. A pixel electrode and a common electrode are provided in the same substrate with an insulating film interposed between the electrodes. Application of a voltage across the pixel electrode and the common electrode generates electric fields in both transverse and vertical directions, due to slits in the pixel electrode, in the liquid crystal layer. Thus, alignment of liquid crystal molecules on the electrodes as well as those on the slits can be controlled, thereby achieving a higher aperture ratio than that of an IPS mode.

Unfortunately, however, the picture quality may be deteriorated in an FFS mode by flicker caused by flexoelectric polarization (also known as flexoelectric effect) of liquid crystal molecules. Flexoelectric polarization refers to macroscopic polarization which occurs when liquid crystal molecules have an asymmetric structure due to deformation in the alignment (e.g., spray alignment, bend alignment) of the liquid crystal molecules.

For preventing degradation of liquid crystal materials, so-called AC drive, which involves periodic inversion of the polarity of the potential difference between a pixel electrode and a common electrode, is usually applied in liquid crystal display devices. However, when flexoelectric polarization occurs, liquid crystal molecules to which a positive voltage applied align differently from those to which a negative voltage is applied. Thus, the positive and negative potential differences change the transmissivity. Specifically, if the same potential (potential with the same absolute value) is supplied in a frame-inversion drive in which the polarity of the potential supplied to pixel electrodes is inverted frame by frame, the degrees of brightness are different among the frames. The difference in the brightness is perceived as flicker to human eyes.

In order to solve the problem, for example, a structure is proposed (for example, Patent Literature 1) in which the center portion of a pixel electrode is disposed transversely across the center of a pixel, and comb teeth from the center portion extend upper and lower sides of the pixel. In the structure, the number of the comb teeth extending to the upper side of the pixel is different from that of the comb teeth extending to the lower side of the pixel, while the widths of the comb teeth and the distances between the adjacent comb teeth are uniform. Another structure is proposed (for example, Patent Literature 2) in which pixel electrodes each have a plurality of belt portions; a dummy electrode is provided between the adjacent pixel electrodes while the widths of the comb teeth and the distances between the adjacent comb teeth are uniformly maintained; and a narrower interval is provided between the adjacent pixel electrodes than conventional products.

### CITATION LIST

### Patent Literature

Patent Literature 1: JP 2010-2596 A
Patent Literature 2: JP 2011-169973 A

### SUMMARY OF INVENTION

### Technical Problem

Regarding occurrence of flicker, the present inventors actually examined the difference in the luminance between pixel electrodes to which a positive voltage is applied and those to which a negative voltage is applied. FIG. 23 and FIG. 24 are each a planer photograph of one pixel when a voltage is applied to a pixel electrode in a common FFS mode liquid crystal display device. FIG. 25 and FIG. 26 are each a graph collectively illustrating a schematic cross-sectional view of a pixel electrode and a common electrode and a schematic luminance distribution. In FIG. 23 and FIG. 25, a positive voltage (+2V) is applied to the pixel electrode. In FIG. 24 and FIG. 26, a negative voltage (−2V) is applied to the pixel electrode.

As shown in FIG. 25, when a positive voltage is applied to the pixel electrode, the luminance is low at regions corresponding to the regions (lines) on the comb teeth of the pixel electrode, and the luminance is high at regions corresponding to the intervals (slits) between the comb teeth of the pixel electrode. Thus, a plurality of dark lines appear along the regions (lines) on the comb teeth of the pixel electrode as shown in FIG. 23 and FIG. 25.

In contrast, as shown in FIG. 26, when a negative voltage is applied to the pixel electrode, the luminance is high at regions corresponding to the regions (lines) on the comb teeth of the pixel electrode, and the luminance is low at regions corresponding to the intervals (slits) between the comb teeth of the pixel electrode. Thus, a plurality of dark lines appear along the intervals (slits) between the pixel electrodes as shown in FIG. 24 and FIG. 26.

The present invention is made in view of the current state described above, and aims to provide a liquid crystal display device that can suppress flicker.

### Solution to Problem

The present inventors made various investigations on a method of suppressing flicker, and focused on the difference in the luminance of each pixel between when a positive voltage is applied to a pixel electrode and when a negative voltage is applied to the pixel electrode. They found that, when a ratio of the luminance under negative voltage application to the luminance under positive voltage application is defined as “a luminance ratio”, flicker is less visible as the luminance ratio nears 1.

The present inventors further investigated intensively and found that the level of the luminance ratio can be controlled by changing the width of a plurality of comb teeth of an electrode and the width of a plurality of slits. Specifically, a pair of electrodes consisting of a comb teeth electrode and a flat plate electrode, which are electrically divided by an insulating film, are provided. Assuming that the width of comb teeth of the comb teeth electrode is L, and that the distance between adjacent comb teeth (slits) of the comb teeth electrode is S, at least one of L and S is configured to include different width values in each pixel. Then, appropriate parameters for the width values are set so that the “luminance ratio” nears as close to 1 as possible. Thus, flicker can be suppressed.

Accordingly, the present inventors successfully solved the problem and completed the present invention.

Specific details of the examination process to achieve the liquid crystal display device of the present invention will be described below.

First, the inventors examined the case where the width (L) of the comb teeth is fixed to a certain value, and the width (S) of the slits is set to include plural values. FIG. 1 is a schematic cross-sectional diagram illustrating one alignment example of a pixel electrode and a common electrode in the liquid crystal display device of the present invention. In the liquid crystal display device, the width (L) of the comb teeth of a pixel electrode 11 is fixed, whereas the width (S) of the slits is not fixed. That is, the plurality of slits include at least two slits having different widths in the pixel electrode 11, and the plurality of comb teeth have the same width. A common electrode 15 is disposed under the pixel electrode 11.

FIG. 2 is a graph showing a relationship between the width (S) of the slits and the luminance ratio (=luminance under negative voltage application/luminance under positive voltage application) when the width (L) of the comb teeth is fixed, and the width (S) of the slits varies. In FIG. 2, the line with circle points (∘) shows the case where the width (L) of the comb teeth is fixed to 3.0 μm; the line with diamond points (⋄) shows the case where the width (L) of the comb teeth is fixed to 3.3 μam; the line with triangle points (Δ) shows the case where the width (L) of the comb teeth is fixed to 4.0 μm; and the line with square points (□) shows the case where the width (L) of the comb teeth is fixed to 4.5 μm. Flicker can be suppressed by controlling the widths of the slits with reference to the graph of FIG. 2 so that the total luminance ratio nears 1.

Assuming that the width of a slit is S1 and the width of another slit is S2 among the plurality of slits having different widths; and that the width of a comb tooth is L1 (=L) and the width of another comb tooth is L2 (=L) among the plurality of comb teeth, then possible values of S1 and S2 are examined based on the graph of FIG. 2. Table 1 below shows the values. Table 1 includes the values of the three cases where the width of L of the comb teeth is 3.0 μm, 3.3 μm, or, 4.0 μm. Possible values of S1/L and S2/L are calculated with reference to the possible values of S1 and S2. The values are also shown in Table 1.

TABLE 1

| | S1 (μm) | | S2 (μm) | | S1/L | | S2/L | |
|---|---|---|---|---|---|---|---|---|
| L | Minimum | Maximum | Minimum | Maximum | Minimum | Maximum | Minimum | Maximum |
| (μm) | value | value | value | value | value | value | value | value |
| 3.0 | 3.2 | 4.3 | 4.4 | 5.5 | 1.07 | 1.43 | 1.47 | 1.83 |
| 3.3 | 3.6 | 5.2 | 4.4 | 5.5 | 1.09 | 1.58 | 1.33 | 1.67 |
| 4.0 | 5.2 | 5.3 | 5.5 | 6.1 | 1.30 | 1.33 | 1.38 | 1.53 |

Next, appropriate parameters are examined with reference to Table 1, and thereby conditions of the following formulas (A1) to (A4) are obtained. The present inventors have found that a flicker-suppressing effect can be obtained by satisfying the conditions. In the following formula (A3), S1 and S2 are in the unit of μm. The values in the condition: S1<S2 are rounded to the second place in determining the satisfaction of the condition. In the following formula (A4), L1 and L2 are in the unit of μm. The values in the condition: L1=L2 are rounded to the second place in determining the satisfaction of the condition.

1.07<S1/L2<1.58 (A1)

1.33<S2/L1<1.83 (A2)

S1<S2 (A3)

L1=L2(=L) (A4)

The upper limit of L is not set in the formulas (A1) to (A4). As FIG. 2 shows, each curve has a minimum luminance ratio when the value of L is fixed, and the minimum luminance ratio is 1.02 (S=approximately 5.5) when L=4.5 μm. This suggests that the luminance ratio can be easily neared to 1 when the condition: L≦4.5 μm is satisfied. Thus, L preferably satisfies the following formula (A5):

L≦4.5 μm (A5).

The lower limit of L is not set in the formulas (A1) to (A4). FIG. 2 suggests that a smaller L may enable sufficient suppression of flicker. Considering the level of voltages actually applied to a liquid crystal layer, design limits, or the like, L preferably satisfies the following formula (A6):

2.0 μm≦L (A6).

The upper limits and the lower limits of S1 and S2 are not shown in the formulas (A1) to (A4). Considering the features of the curves in FIG. 2, the upper limits and the lower limits of S1 and S2 are not necessarily specified for finally allowing the luminance ratio to near 1. Table 1 shows the minimum values and the maximum values of S1 and S2 in mainly the left side of the minimum point of each line. The minimum values and the maximum values of S1/L and S2/L can be appropriately set by examining at least the left side of the minimum point since the luminance ratio changes less on the right side of the minimum point than on the left side. Yet, considering the luminance ratio at the minimum point of each line, S1 preferably satisfies the following formula (A7):

3.5 μm≦S1 (A7).

Too large the width of the slits of the pixel electrode may fail to apply sufficient voltages in a liquid crystal layer, which may reduce the transmissivity. Considering the transmissivity, S2 preferably satisfies the following formula (A8):

S2≦7.5 μm (A8).

As described above, flicker is most suppressed when the luminance ratio is 1.00. For this reason, the values of S1 and S2 are preferably set based on the luminance ratio. Considering FIG. 2, specifically, S1 and S2 preferably satisfy the following formulas (A9) and (A10):

S1<4.5 μm (A9)

4.5 μm<S2 (A10).

In actual mass production, the width of the comb teeth of the pixel electrode may not be formed as designed depending on the accuracy of exposure, etching, or the like in photolithography. An error in the width of the comb teeth of the pixel electrode due to variance from the designed values may occur commonly in the comb teeth. The error affects the width of the slits. That is, if the width of the comb teeth varies to a larger degree, all the slits are narrower. If the width of the comb teeth varies to a smaller degree, all the slits are wider. Meanwhile, all the curves in FIG. 2 are nearly symmetrical to the respective minimum points. Considering the above, the widths of S1 and S2 of the slits having different widths are preferably set to a smaller value and a larger value, respectively, than the width of the slit corresponding to the minimum point. This setting offsets the variance of the luminance ratio from 1 even in the case where the width of the slits varies in either degree from the designed value. Thus, S1 and S2 preferably satisfy the following formulas (A11) and (A12):

S1<5.5 μm (A11)

5.5 μm<S2 (A12).

Next, assuming that the width of a slit is S1 and the width of another slit is S2 among the plurality of slits having different widths; and that the width of a comb tooth is L1 (=L) and the width of another comb tooth is L2 (=L) among the plurality of comb teeth, the tendency of the luminance ratio in relation to the values of S1/L and S2/L is examined. FIGS. 3 to 5 each are a graph showing a relationship between S1/L and S2/L. The sample luminance ratios are 0.99, 1.00, and 1.01. FIG. 3 is a graph when the width (L) of the comb teeth is 3.0 μm. FIG. 4 is a graph when the width (L) of the comb teeth is 3.3 μm. The graphs when the widths (L) of the comb teeth are 3.0 μm and 3.3 μm are collectively shown in FIG. 5. An approximate line is drawn for each luminance ratio in FIG. 5. FIGS. 3 to 5 indicate that the tendency of the relationship between S1/L and S2/L is almost the same among the cases with different widths (L) of the comb teeth, and that the tendency of the relationship between S1/L and S2/L is almost the same among the cases with different luminance ratios.

Appropriate parameters are examined based on the approximate lines. Thus, the following relational formulas (B1) to (B8) are obtained. In the following formula (B4), S1 and S2 are in the unit of μm. The values in the condition: S1<S2 are rounded to the second place in determining the satisfaction of the condition. In the following formula (B5), L1 and L2 are in the unit of μm. The values in the condition: L1=L2 are rounded to the second place in determining the satisfaction of the condition.

Y=aX²+bX+c (B1)

Y=S1/L2 (B2)

X=S2/L1 (B3)

S1<S2 (B4)

L1=L2 (B5)

0.50≦a≦0.64 (B6)

−2.40≦b≦−1.86 (B7)

2.78≦c≦3.52 (B8)

Ranges of acceptable errors for the values of the above a, b, and c are determined and expressed as the formulas (B6) to (B8) with reference to the following Table 2.

TABLE 2

| Luminance | | | |
|---|---|---|---|
| ratio | a | b | c |
| 0.99 | 0.5638 | −2.1997 | 3.4150 |
| 1.00 | 0.5711 | −2.1312 | 3.1538 |
| 1.01 | 0.5045 | −1.8592 | 2.7795 |

The upper limit and the lower limit of L are not set in the formulas (B1) to (B8). Considering the examination results,

L preferably satisfies the following formula (B9):

L≦4.5 μm (B9),

and also satisfies the following formula (B10):

2.0 μm≦L (B10).

The upper limits and the lower limits of S1 and S2 are not set in the formulas (B1) to (B8). Considering the examination results, S1 preferably satisfies the following formula (B11):

3.5 μm≦S1 (B11),

and S2 preferably satisfies the following formula (B12):

S2≦7.5 μm (B12).

Similarly, S1 and S2 preferably satisfy the following formulas (B13) and (B14):

S1<4.5 μm (B13)

4.5 μm<S2 (B14).

From other viewpoints, S1 and S2 preferably satisfy the following formulas (B15) and (B16):

S1<5.5 μm (B15)

5.5 μm<S2 (B16).

Any of the formulas (A1) to (A4) and (B1) to (B8) is for the case where the width (L) of the comb teeth is fixed, and the width (S) of the slits is not fixed in the pixel electrode. Thus, the conditions may be combined with one another. Furthermore, a flicker suppressing effect can be enhanced when the parameters are set so that all the conditions are satisfied.

That is, L1, L2, S1, and S2 preferably satisfy all of the formulas (A1) to (A4) and the formulas (B1) to (B8), and more preferably further satisfy the formulas (A5) to (A12) or the formulas (B9) to (B16).

Next, the inventors examined the case where the width (S) of the slits is fixed to a certain value, and the width (L) of the comb teeth is set to include plural values. FIG. 6 is a schematic cross-sectional diagram illustrating another alignment example of the pixel electrode and the common electrode in the liquid crystal display device of the present invention. In the liquid crystal display device, the width (S) of the slits of the pixel electrode 11 is fixed, whereas the width (L) of the comb teeth is not fixed. That is, the plurality of slits have the same width in the pixel electrode 11, and the plurality of comb teeth include at least two comb teeth having different widths. A common electrode 15 is disposed under the pixel electrode 11.

FIG. 7 is a graph showing a relationship between the width (L) of the comb teeth and the luminance ratio (=luminance under negative voltage application/luminance under positive voltage application) when the width (S) of the slits is fixed, and the width (L) of the comb teeth varies. In FIG. 7, the line with circle points (∘) shows the case where the width (S) of the slits is fixed to 3.6 μm; the line with triangle points (Δ) shows the case where the width (S) of the slits is fixed to 4.6 μm; and the line with square points (□) shows the case where the width (S) of the slits is fixed to 5.6 μm. Flicker can be suppressed by controlling the widths of the slits with reference to the graph of FIG. 7 so that the total luminance ratio nears 1.

Assuming that the width of a comb tooth is L1 and the width of another comb tooth is L2 among the plurality of comb teeth having different widths; and that the width of a slit is S1 (=S) and the width of another slit is S2 (=S) among the plurality of slits, possible values of L1 and L2 are examined based on the graph of FIG. 7. Table 3 below shows the values. Table 3 includes the values of the cases when the width of L of the comb teeth is 3.6 μm or 4.6 μm. Possible values of S/L1 and S/L2 are calculated with reference to the possible values of L1 and L2. The values are also shown in Table 3.

TABLE 3

| | L1 (μm) | | L2 (μm) | | S/L1 | | S/L2 | |
|---|---|---|---|---|---|---|---|---|
| S | Minimum | Maximum | Minimum | Maximum | Minimum | Maximum | Minimum | Maximum |
| (μm) | value | value | value | value | value | value | value | value |
| 3.6 | 2.5 | 2.7 | 2.6 | 3.2 | 1.33 | 1.44 | 1.13 | 1.38 |
| 4.6 | 2.5 | 3.5 | 3.2 | 5.0 | 1.31 | 1.84 | 0.92 | 1.44 |

Next, appropriate parameters are examined with reference to Table 3. Thus, conditions of the following formulas (C1) to (C4) are obtained. The present inventors have found that a flicker-suppressing effect can be obtained by satisfying the conditions. In the following formula (C3), L1 and L2 are in the unit of μm. The values in the condition: L1<L2 are rounded to the second place in determining the satisfaction of the condition. In the following formula (C4), S1 and S2 are in the unit of μm. The values of the condition: S1=S2 are rounded to the second place in determining the satisfaction of the condition.

0.92<S1/L2<1.44 (C1)

1.31<S2/L1<1.84 (C2)

L1<L2 (C3)

S1=S2 (C4)

The upper limit of S is not set in the formulas (C1) to (C4). As FIG. 7 shows, each curve has the maximum luminance ratio when the value of S is fixed, and the maximum luminance ratio is found at a point of L=5.5 μm when S=5.6 μm. This suggests that the luminance ratio can be easily neared to 1 when the condition: S≦5.6 μm is satisfied. Thus, S preferably satisfies the following formula (C5):

S≦5.6 μm (C5).

The lower limit of S is not set in the formulas (C1) to (C4). FIG. 7 suggests that a smaller S enables sufficient suppression of flicker. Considering the level of voltages actually applied to a liquid crystal layer, design limits, or the like, S preferably satisfies the following formula (C6):

2.0 μm≦S (C6).

The upper limits and the lower limits of L1 and L2 are not shown in the formulas (C1) to (C4). Considering the features of the curves in FIG. 7, the upper limits and the lower limits of L1 and L2 are not necessarily specified for finally allowing the luminance ratio to near 1. Table 3 shows the minimum values and the maximum values of L1 and L2 in mainly the left side of the maximum point of each line. The minimum values and the maximum values of S/L1 and S/L2 can be appropriately set by examining at least the left side of the maximum points since the luminance ratio changes less on the right side of the minimum point than on the left side. Yet, considering the luminance ratio at the maximum point of each line, L1 preferably satisfies the following formula (C7): 2.5 μm≦L1 (C7).

Too large the width of the slits of the pixel electrode may fail to apply sufficient voltages in a liquid crystal layer, which may reduce the transmissivity. Considering the transmissivity, L2 preferably satisfies the following formula (C8):

L2≦7.5 μm (C8).

As described above, flicker is most suppressed when the luminance ratio is 1.00. For this reason, the values of L1 and L2 are preferably set based on the luminance ratio. Considering FIG. 7, specifically, L1 and L2 preferably satisfy the following formulas (C9) and (C10):

L1<3.7 μm (C9)

3.7 μm<L2 (C10).

In actual mass production, the width of the comb teeth of the pixel electrode may not be formed as designed depending on the accuracy of exposure, etching, or the like in photolithography. An error in the width of the comb teeth of the pixel electrode due to variance from the designed values may occur commonly in the comb teeth. That is, if the width of the comb teeth varies to a larger degree, all the comb teeth are wider. If the width of the comb teeth varies to a smaller degree, all the comb teeth are narrower. Meanwhile, all the curves in FIG. 7 are nearly symmetrical to the respective maximum points. Considering the above, the widths of L1 and L2 of the comb teeth having different widths are preferably set to a smaller value and a larger value, respectively, than the width of the comb tooth corresponding to the maximum point. This setting offsets the variance of the luminance ratio from 1 even in the case where the width of the comb teeth varies in either degree from the designed value. Thus, L1 and L2 preferably satisfy the following formulas (C11) and (C12):

L1<4.5 μm (C11)

4.5 μm<L2 (C12).

Next, assuming that the width of a comb tooth is L1 (=L) and the width of another comb tooth is L2 among the plurality of comb teeth having different widths; and that the width of slits is S, the tendency of the luminance ratio in relation to the values of S/L1 and S/L2 is examined. FIGS. 8 to 10 each are a graph showing a relationship between S/L1 and S/L2. The sample luminance ratios are 0.99, 1.00, and 1.01. FIG. 8 is a graph when the width (S) of the slits is 3.6 μm. FIG. 9 is a graph when the width (S) of the slits is 4.6 μm. The graphs when the widths (L) of the slits are 3.6 μm and 4.6 μm are collectively shown in FIG. 10. An approximate line is drawn for each luminance ratio in FIG. 10. FIGS. 8 to 10 indicate that the tendency of the relationship between S/L1 and S/L2 is almost the same among the cases with different widths (S) of the slits, and that the tendency of the relationship between S/L1 and S/L2 is almost the same among the cases with different luminance ratios.

Appropriate parameters are examined based on the approximate lines. Thus, the following relational formulas (D1) to (D8) are obtained. In the following formula (D4), L1 and L2 are in the unit of μm. The values in the condition: L1<L2 are rounded to the second place in determining the satisfaction of the condition. In the following formula (D5), S1 and S2 are in the unit of μm. The values of the condition: S1=S2 are rounded to the second place in determining the satisfaction of the condition.

Y=aX²+bX+c (D1)

Y=S1/L2 (D2)

X=S2/L1 (D3)

L1<L2 (D4)

S1=S2 (D5)

7.6≦a≦16.0 (D6)

−22.5≦b≦−13.1 (D7)

6.35≦c≦8.55 (D8)

Ranges of acceptable errors for the values of the above a, b, and c are determined and expressed as the formulas (D6) to (D8) with reference to the following Table 4.

TABLE 4

| Luminance | | | |
|---|---|---|---|
| ratio | a | b | c |
| 0.99 | 7.6261 | −13.079 | 6.3112 |
| 1.00 | 11.804 | −17.844 | 7.4536 |
| 1.01 | 12.534 | −17.327 | 6.6850 |

The upper limit and the lower limit of S are not set in the formulas (D1) to (D8). Considering the examination results, S preferably satisfies the following formula (D9):

S≦5.6 μm (D9),

and also preferably satisfies the following formula (D10):

2.0 μm≦S (D10).

The upper limits and the lower limits of L1 and L2 are not shown in the formulas (D1) to (D8). Considering the examination results, L1 preferably satisfies the following formula (D11):

2.5 μm≦L1 (D11),

and L2 preferably satisfies the following formula (D12):

L2≦7.5 μm (D12).

Similarly, L1 and L2 preferably satisfy the following formulas (D13) and (D14):

L1<3.7 μm (D13)

3.7 μm<L2 (D14).

From other viewpoints, L1 and L2 preferably satisfy the following formulas (D15) and (D16):

L1<4.5 μm (D15)

4.5 μm<L2 (D16).

Any of the formulas (C1) to (C4) and (D1) to (D8) is for the case where the width (S) of the slits is fixed, and the width (L) of the comb teeth is not fixed in the pixel electrode. Thus, the conditions may be combined with one another. Furthermore, a flicker suppressing effect can be enhanced when the parameters are set so that all the conditions are satisfied.

That is, L1, L2, S1, and S2 preferably satisfy all of the formulas (C1) to (C4) and the formulas (D1) to (D8), and more preferably further satisfy the formulas (C5) to (C12) or the formulas (D9) to (D16).

Next, the inventors examined the case where the width (S) of the slits is set to include plural values, and the width (L) of the comb teeth is also set to include plural values. In this case, both the plurality of slits and the plurality of comb teeth include at least two parts having different widths from one another. That is, the plurality of slits include at least two slits having different widths from one another in the pixel electrode, and the plurality of comb teeth include at least two comb teeth having different widths from one another.

The size of the width (S) of the slits and the size of the width (L) of the comb teeth are determined based on Table 1 and Table 3. Table 5 is a table combining Table 1 and Table 3.

TABLE 5

| | S1 (μm) | | S2 (μm) | | S1/L | | S2/L | |
|---|---|---|---|---|---|---|---|---|
| L | Minimum | Maximum | Minimum | Maximum | Minimum | Maximum | Minimum | Maximum |
| (μm) | value | value | value | value | value | value | value | value |
| 3.0 | 3.2 | 4.3 | 4.4 | 5.5 | 1.07 | 1.43 | 1.47 | 1.83 |
| 3.3 | 3.6 | 5.2 | 4.4 | 5.5 | 1.09 | 1.58 | 1.33 | 1.67 |
| 4.0 | 5.2 | 5.3 | 5.5 | 6.1 | 1.30 | 1.33 | 1.38 | 1.53 |
| | L1 (μm) | | L2 (μm) | | S/L1 | | S/L2 | |
| S | Minimum | Maximum | Minimum | Maximum | Minimum | Maximum | Minimum | Maximum |
| (μm) | value | value | value | value | value | value | value | value |
| 3.6 | 2.5 | 2.7 | 2.6 | 3.2 | 1.33 | 1.44 | 1.13 | 1.38 |
| 4.6 | 2.5 | 3.5 | 3.2 | 5.0 | 1.31 | 1.84 | 0.92 | 1.44 |

Next, appropriate parameters are examined with reference to Table 5. Thus, conditions of the following formulas (E1) to (E4′) are obtained. The present inventors have found that a flicker-suppressing effect can be obtained when L1, L2, S1, and S2 satisfy the conditions. In the following formula (E3′), S1 and S2 are in the unit of μm. The values in the condition: S1<S2 are rounded to the second place in determining the satisfaction of the condition. In the following formula (E4′), L1 and L2 are in the unit of μm. The values in the condition: L1<L2 are rounded to the second place in determining the satisfaction of the condition.

0.92<S1/L2<1.58 (E1)

1.31<S2/L1<1.84 (E2)

S1<S2 (E3′)

L1<L2 (E4′)

Summarizing the above, the present inventors have found that, when at least either of the width (S) of the slits and the width (L) of the comb teeth is set to include plural values, a flicker-suppressing effect can be obtained by satisfying the following relational formulas (E1) to (E4). In the following formula (E3), S1 and S2 are in the unit of μm. The values of the conditions: S1<S2 and S1=S2 are rounded to the second place in determining the satisfaction of the conditions. In the following formula (E4), L1 and L2 are in the unit of μm. The values of the conditions: L1<L2 and L1=L2 are rounded to the second place in determining the satisfaction of the conditions.

0.92<S1/L2<1.58 (E1)

1.31<S2/L1<1.84 (E2)

S1≦S2 (E3)

L1≦L2 (E4)

In the formulas, S1 and L1 are not simultaneously equal to S2 and L2, respectively.

The upper limits and the lower limits of S1 and S2 are not shown in the formulas (E1) to (E4). Considering the examination results, S1 preferably satisfies the following formula (E5):

2.0 μm≦S1≦5.6 μm (E5),

and S2 preferably satisfies the following formula (E6):

2.0 μm≦S2≦7.5 μm (E6).

The upper limits and the lower limits of L1 and L2 are not shown in the formulas (E1) to (E4). Considering the examination results, L1 preferably satisfies the following formula (E7):

2.0 μm≦L1≦4.5 μm (E7),

and L2 preferably satisfies the following formula (E8):

2.0 μm≦L2≦7.5 μm (E8).

Next, the present inventors have verified the design of a liquid crystal display device further incorporating a concept of the area ratios of slits having different widths and/or comb teeth having different widths based on the above examination.

FIGS. 11 to 13 each are a graph showing a relationship between S1/L and S2/L when the width (L) of the comb teeth is fixed, and the width (S) of the slits varies. Each graph shows comparison between cases with different area ratios. The different widths of S1 and S2 of slits are in a relationship of S1<S2 as in the above description.

In FIGS. 11 to 13, FIG. 11 includes the data when the luminance ratio is 0.99; FIG. 12 includes the data when the luminance ratio is 1.00; and FIG. 13 includes the data when the luminance ratio is 1.01. Asymptotes when the values of S1 and S2 are each close to the infinite value are also drawn in FIG. 12.

In FIGS. 11 to 13, the line with circle points (0) shows the case satisfying “area of slits having a width of S1:area of slits having a width of S2=3:1”; the line with diamond points (⋄) shows the case satisfying “area of slits having a width of S1:area of slits having a width of S2=2:1”; the line with square points (□) shows the case satisfying “area of slits having a width of S1:area of slits having a width of S2=1:1”; the line with triangle points (A) shows the case satisfying “area of slits having a width of S1: area of slits having a width of S2=1:2”; and the line with cross points (x) shows the case satisfying “area of slits having a width of S1:area of slits having a width of S2=1:3”.

A study of FIGS. 11 to 13 reveals that a curve showing the case with a larger area of slits having a width of S1 forms a more horizontal (inclination: 0) slope than a curve showing the case with a larger area of slits having a width of S2. In other words, variation in the value of S2 causes small change in the value of S1/L, which means that a larger area of slits having a width of S1 than the area of slits having a width of S2 causes less change in the luminance even with an error in the line width in the process. Thus, the area of slits having a width of S1 is preferably larger than the area of slits having a width of S2.

The curves are crossed at one point in all FIGS. 11 to 13. A relation of S1/L=S2/L is satisfied at this point. For example, if the luminance ratio is 1.00, then S1/L=S2/L=1.36. An infinitely large area of slits having a width of S1 provides an asymptote parallel with the horizontal axis. An infinitely large area of slits having a width of S2 provides an asymptote parallel with the vertical axis. Accordingly, in the case of the luminance ratio of 1.00, possible values of S1/L and S2/L when the areas are changed should be located in the lower right area (shaded area) from the crosspoint of the two asymptotes in FIG. 14. Thus, a flicker suppressing effect can be obtained by setting the values of L, S1 and S2 so that the values of S1/L and S2/L are located in the region.

The inventors also examined the cases of the luminance ratio of 0.99 and the luminance ratio of 1.01 based on the above examination. Table 6 shows the examination result.

TABLE 6

Luminance ratio

| | | | | | |
|---|---|---|---|---|---|
| 0.99 | 1.00 | 1.01 | 0.99 | 1.00 | 1.01 |

| | | |
|---|---|---|
| L (μm) | S (μm) | S/L(=S1/L = S2/L) |

| | | | | | | |
|---|---|---|---|---|---|---|
| 3.0 | 3.8 | 4.0 | 4.3 | 1.27 | 1.33 | 1.43 |
| 3.3 | 4.2 | 4.5 | 4.8 | 1.27 | 1.36 | 1.45 |
| 4.0 | — | — | 5.5 | — | — | 1.38 |

Next, appropriate parameters are examined with reference to Table 6. Thus, conditions of the following formulas (F1) to (F6) are obtained. The present inventors have found that a flicker-suppressing effect can be obtained by satisfying the conditions. In the following formula (F5), S1 and S2 are in the unit of μm. The values in the condition: S1<S2 are rounded to the second place in determining the satisfaction of the condition. In the following formula (F6), L1 and L2 are in the unit of μm. The values in the condition: L1=L2 are rounded to the second place in determining the satisfaction of the condition.

S1/L2<W (F1)

Z<S2/L1 (F2)

1.27<W<1.45 (F3)

1.27<Z<1.45 (F4)

S1<S2 (F5)

L1=L2 (F6)

The inventors also examined the ratio between the area of comb teeth having a width of L1 and the area of comb teeth having a width of L2 in the same manner as the ratio between the area of slits having a width of S1 and the area of slits having a width of S2. The examination result shown in Table 7 is further obtained.

TABLE 7

Luminance ratio

| | | | | | |
|---|---|---|---|---|---|
| 0.99 | 1.00 | 1.01 | 0.99 | 1.00 | 1.01 |

| | | |
|---|---|---|
| S (μm) | L (μm) | S/L(=S/L1 = S/L2) |

| | | | | | | |
|---|---|---|---|---|---|---|
| 3.6 | 2.6 | 2.7 | 2.8 | 1.38 | 1.33 | 1.29 |
| 4.6 | 3.1 | 3.3 | 3.6 | 1.48 | 1.39 | 1.28 |
| 5.6 | 3.5 | 3.7 | 4.0 | 1.60 | 1.51 | 1.40 |

Next, appropriate parameters are examined with reference to Table 7. Thus, conditions of the following formulas (G1) to (G6) are obtained. The present inventors have found that a flicker-suppressing effect can be obtained by satisfying the conditions. In the following formula (G5), S1 and S2 are in the unit of μm. The values of the condition: S1=S2 are rounded to the second place in determining the satisfaction of the condition. In the following formula (G6), L1 and L2 are in the unit of μm. The values in the condition: L1<L2 are rounded to the second place in determining the satisfaction of the condition.

S1/L2<W (G1)

Z<S2/L1 (G2)

1.28<W<1.60 (G3)

1.28<Z<1.60 (G4)

S1=S2 (G5)

L1<L2 (G6)

Next, appropriate parameters are examined with reference to Tables 6 and 7. Thus, conditions of the following formulas (H1) to (H6′) are obtained when the width (S) of the slits is set to include plural values, and the width (L) of the comb teeth is also set to include plural values. The present inventors have found that a flicker-suppressing effect can be obtained when L1, L2, S1, and S2 satisfy the conditions. In the following formula (H5′), S1 and S2 are in the unit of μm. The values in the condition: S1<S2 are rounded to the second place in determining the satisfaction of the condition. In the following formula (H6′), L1 and L2 are in the unit of μm. The values in the condition: L1<L2 are rounded to the second place in determining the satisfaction of the condition.

S1/L2<W (H1)

Z<S2/L1 (H2)

1.27<W<1.60 (H3)

1.27<Z<1.60 (H4)

S1<S2 (H5′)

L1<L2 (H6′)

Summarizing the above, the present inventors have found that, when at least either of the width (S) of the slits and the width (L) of the comb teeth is set to include plural values, a flicker-suppressing effect can be obtained by satisfying the following relational formulas (H1) to (H6). In the following formula (H5), S1 and S2 are in the unit of μm. The values of the conditions: S1<S2 and S1=S2 are rounded to the second place in determining the satisfaction of the conditions. In the following formula (H6), L1 and L2 are in the unit of μm. The values of the conditions: L1<L2 and L1=L2 are rounded to the second place in determining the satisfaction of the conditions.

S1/L2<W (H1)

Z<S2/L1 (H2)

1.27<W<1.60 (H3)

1.27<Z<1.60 (H4)

S1≦S2 (H5)

L1≦L2 (H6)

In the formulas, S1 and L1 are not simultaneously equal to S2 and L2, respectively.

Accordingly, one aspect of the present invention is a liquid crystal display device that includes a pair of substrates; and a liquid crystal layer interposed between the pair of substrates, at least one of the pair of substrates including a first electrode that includes at least two parallel comb teeth and at least two parallel slits, a second plate electrode, and an insulating film that separates the first electrode and the second electrode into different layers, assuming that the width of a comb tooth is L1 and the width of another comb tooth is L2 among the at least two comb teeth; and that the width of a slit is S1 and the width of another slit is S2 among the at least two slits, then L1, L2, S1, and S2 satisfy the following formulas (H1) to (H6):

S1/L2<W (H1)

Z<S2/L1 (H2)

1.27<W<1.60 (H3)

1.27<Z<1.60 (H4)

S1≦S2 (H5)

L1≦L2 (H6)

provided that S1 and L1 are not simultaneously equal to S2 and L2, respectively; when the at least two slits include three or more slits having different widths, S1 is set as the minimum width, and S2 is set as the maximum width; and when the at least two comb teeth include three or more comb teeth having different widths, L1 is set as the minimum width, and L2 is set as the maximum width.

In the liquid crystal display device, when the width (L) of the comb teeth is fixed to a certain value, and the width (S) of the slits is set to include plural values, L1, L2, S1, and S2 preferably satisfy the following formulas (F1) to (F6):

S1/L2<W (F1)

Z<S2/L1 (F2)

1.27<W<1.45 (F3)

1.27<Z<1.45 (F4)

S1<S2 (F5)

L1=L2 (F6).

In the liquid crystal display device, when the width (S) of the slits is fixed to a certain value, and the width (L) of the comb teeth is set to include plural values, L1, L2, S1, and S2 preferably satisfy the following formulas (G1) to (G6):

S1/L2<W (G1)

Z<S2/L1 (G2)

1.28<W<1.60 (G3)

1.28<Z<1.60 (G4)

S1=S2 (G5)

L1<L2 (G6).

The above parameters are applicable to any case of the area ratios of the plurality of slits and the area ratios of the plurality of comb teeth. If the area ratios of the plurality of slits are almost the same, and the area ratios of the plurality of comb teeth are almost the same, the following conditions may be provided.

That is, L1, L2, S1, and S2 preferably satisfy the following formulas (E1) to (E4):

0.92<S1/L2<1.58 (E1)

1.31<S2/L1<1.84 (E2)

S1≦S2 (E3)

L1≦L2 (E4)

provided that S1 and L1 are not simultaneously equal to S2 and L2, respectively.

In the liquid crystal display device, when the width (L) of the comb teeth is fixed to a certain value, and the width (S) of the slits is set to include plural values, L1, L2, S1, and S2 preferably satisfy the following formulas (A1) to (A4):

1.07<S1/L2<1.58 (A1)

1.33<S2/L1<1.83 (A2)

S1<S2 (A3)

L1=L2 (A4),

or L1, L2, S1, and S2 preferably satisfy the following formulas (B1) to (B8):

Y=aX²+bX+c (B1)

Y=S1/L2 (B2)

X=S2/L1 (B3)

S1<S2 (B4)

L1=L2 (B5)

0.50≦a≦0.64 (B6)

−2.40≦b≦−1.86 (B7)

2.78≦c≦3.52 (B8).

In the liquid crystal display device, when the width (L) of the comb teeth is fixed to a certain value, and the width (S) of the slits is set to include plural values, L1, L2, S1, and S2 preferably satisfy the following formulas (C1) to (C4):

0.92<S1/L2<1.44 (C1)

1.31<S2/L1<1.84 (C2)

L1<L2 (C3)

S1=S2 (C4), or

L1, L2, S1, and S2 preferably satisfy the following formulas (D1) to (D8):

Y=aX2+bX+c (D1)

Y=S1/L2 (D2)

X=S2/L1 (D3)

L1<L2 (D4)

S1=S2 (D5)

7.6≦a≦16.0 (D6)

−22.5≦b≦−13.1 (D7)

6.35≦c≦8.55 (D8).

### Advantageous Effects of Invention

The present invention enables production of a liquid crystal display device that can suppress flicker.

### BRIEF DESCRIPTION OF DRAWINGS

FIG. 1 is a schematic cross-sectional diagram illustrating one alignment example of a pixel electrode and a common electrode in the liquid crystal display device of the present invention.

FIG. 2 is a graph showing a relationship between the width S) of the slits and the luminance ratio when the width (L) of the comb teeth is fixed, and the width (S) of the slits varies.

FIG. 3 is a graph showing a relationship between S1/L and S2/L when the width (L) of the comb teeth is 3.0 μm.

FIG. 4 is a graph showing a relationship between S1/L and S2/L when the width (L) of the comb teeth is 3.3 μm.

FIG. 5 is a graph showing a relationship between S1/L and S2/L when the width (L) of the comb teeth includes 3.0 μm and 3.3 μm.

FIG. 6 is a schematic cross-sectional diagram illustrating another alignment example of the pixel electrode and the common electrode in the liquid crystal display device of the present invention.

FIG. 7 is a graph showing a relationship between the width (L) of the comb teeth and the luminance ratio when the width (S) of the slits is fixed, and the width (L) of the comb teeth varies.

FIG. 8 is a graph showing a relationship between S/L1 and S/L2 when the width (S) of the slits is 3.6 μm.

FIG. 9 is a graph showing a relationship between S/L1 and S/L2 when the width (S) of the slits is 4.6 μm.

FIG. 10 is a graph showing a relationship between S/L1 and S/L2 when the width (S) of the slits includes 3.6 μm and 4.6 μm.

FIG. 11 is a graph showing a relationship between S/L1 and S/L2 when the width (L) of the comb teeth is fixed, and the width (S) of the slits varies. FIG. 11 includes the data when the luminance ratio is 0.99.

FIG. 12 is a graph showing a relationship between S/L1 and S/L2 when the width (L) of the comb teeth is fixed, and the width (S) of the slits varies. FIG. 11 includes the data when the luminance ratio is 1.00.

FIG. 13 is a graph showing a relationship between S/L1 and S/L2 when the width (L) of the comb teeth is fixed, and the width (S) of the slits varies. FIG. 11 includes the data when the luminance ratio is 1.01.

FIG. 14 is a graph showing the two asymptotes extracted from FIG. 12.

FIG. 15 is a schematic perspective view illustrating a liquid crystal display device of Embodiment 1.

FIG. 16 is a schematic plan view illustrating the pixel structure of a TFT substrate of Embodiment 1.

FIG. 17 is a schematic plan view illustrating another example of the pixel structure of a TFT substrate of Embodiment 1.

FIG. 18 is a schematic cross-sectional view of a liquid crystal display device of Embodiment 1.

FIG. 19 is an enlarged schematic plan view illustrating the vicinity of comb teeth of the pixel electrode shown in FIG. 16.

FIG. 20 is a schematic view illustrating a pattern in the case where voltages of different polarities are applied to longitudinally extending lines.

FIG. 21 is a schematic view illustrating a pattern in the case where voltages of different polarities are applied to longitudinally extending lines with one kind of the lines being shown in black.

FIG. 22 is a graph showing a waveform (luminance distribution) under positive polarity and a waveform (luminance distribution) under negative polarity with time on the horizontal axis.

FIG. 23 shows a planar photograph of a pixel of a pixel electrode to which a voltage is applied in a common FFS mode liquid crystal display device. A positive voltage (+2 v) is applied to the pixel electrode.

FIG. 24 shows a planar photograph of a pixel of a pixel electrode to which a voltage is applied in a common FFS mode liquid crystal display device. A negative voltage (−2 v) is applied to the pixel electrode.

FIG. 25 collectively illustrates schematic cross-sectional views of a pixel electrode and a common electrode and a graph schematically showing a luminance distribution. A positive voltage (+2 v) is applied to the pixel electrode.

FIG. 26 collectively illustrates schematic cross-sectional views of a pixel electrode and a common electrode and a graph schematically showing a luminance distribution. A negative voltage (−2 v) is applied to the pixel electrode.

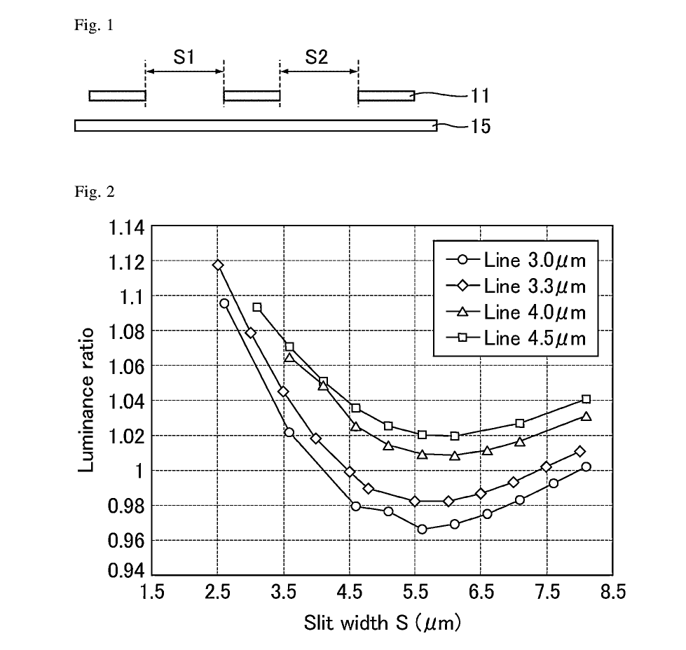

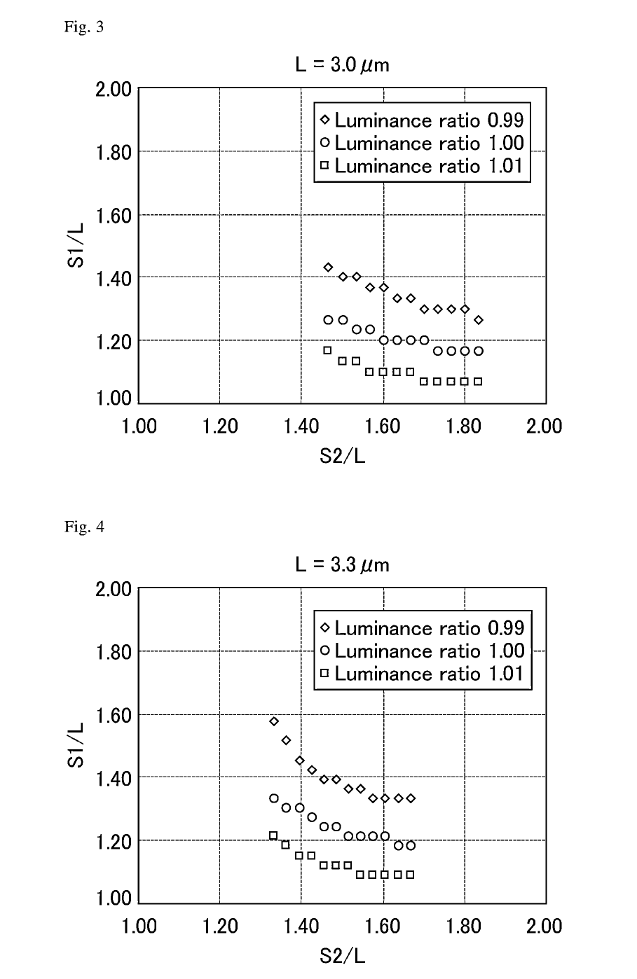

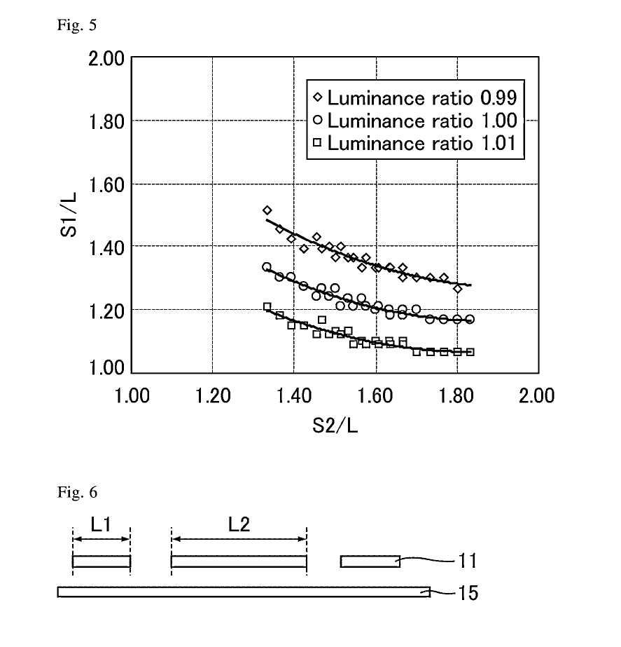

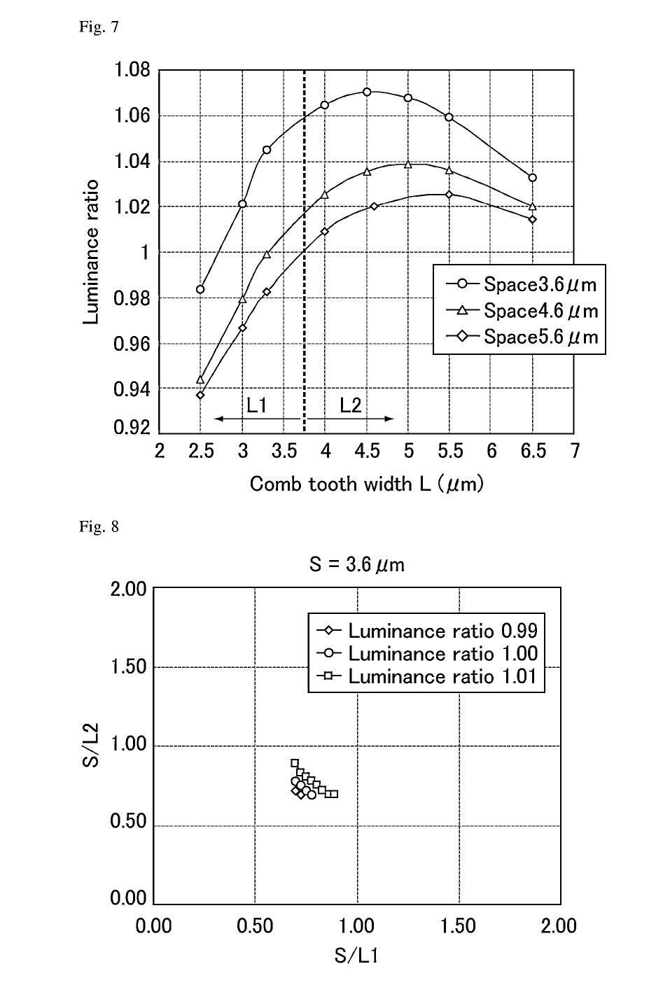

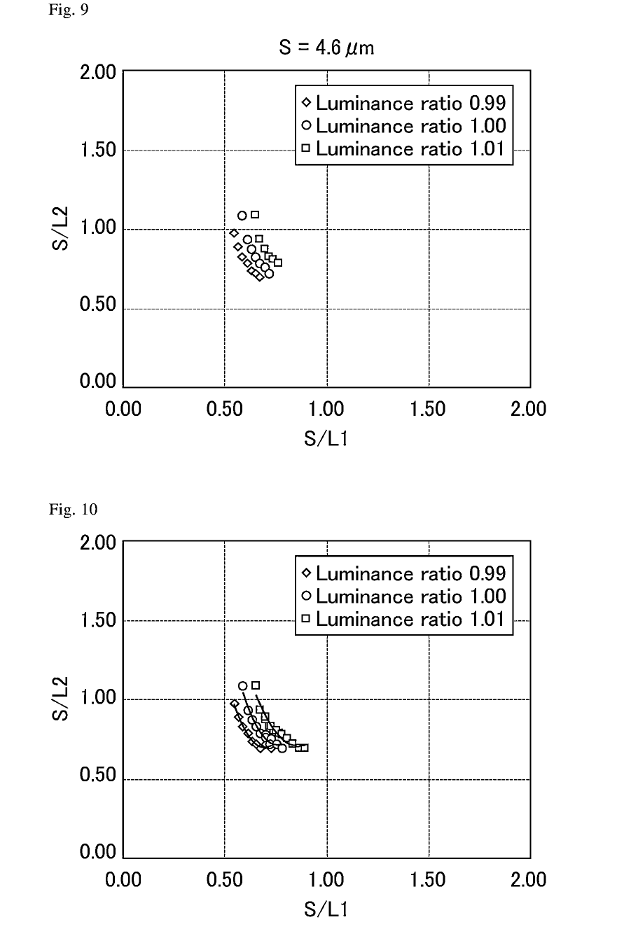

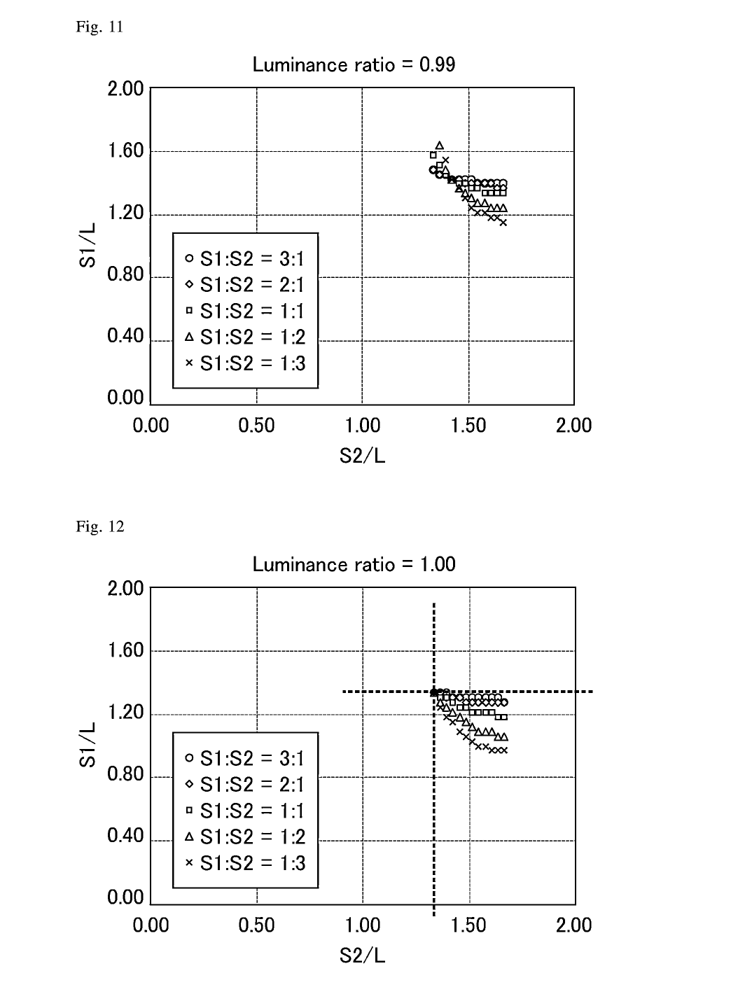

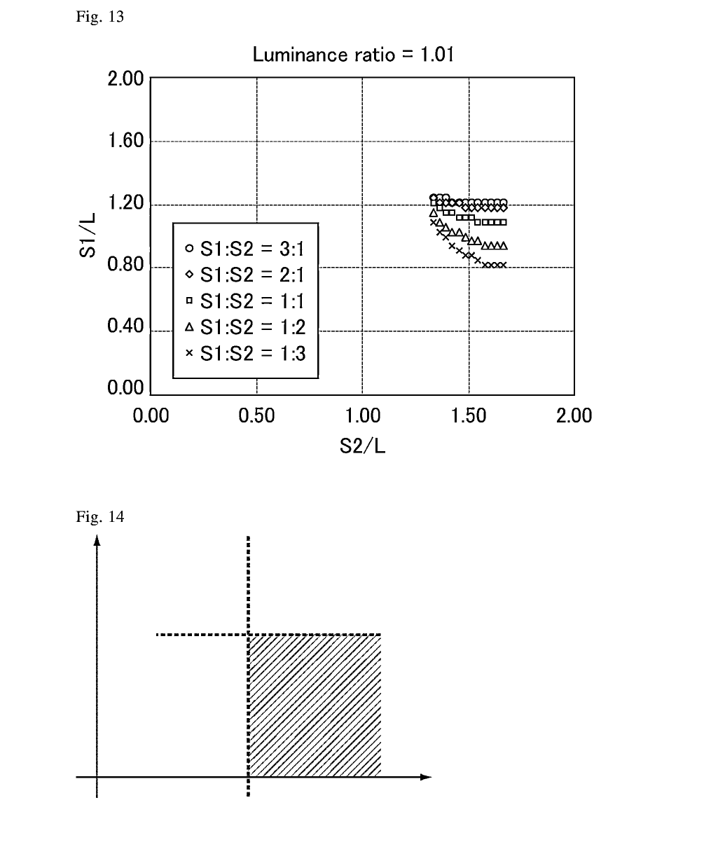

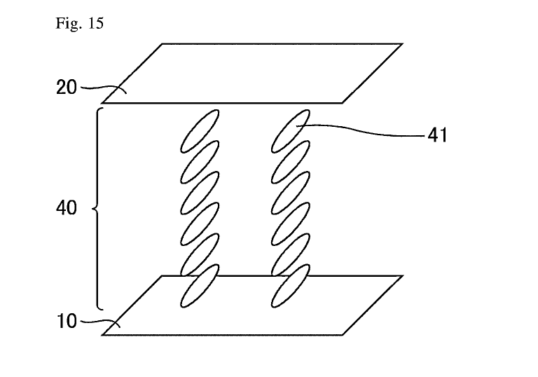

### DESCRIPTION OF EMBODIMENTS

The present invention will be mentioned in more detail referring to the drawings in the following embodiments, but is not limited to these embodiments.

Liquid crystal display devices according to the following Embodiments 1 to 6 can be specifically used in devices such as televisions, personal computers, mobile phones, car navigation systems, and information displays.

### Embodiment 1

FIG. 15 is a schematic perspective view illustrating a liquid crystal display device of Embodiment 1. The liquid crystal display device of Embodiment 1 includes a TFT substrate 10, a counter substrate 20, and a liquid crystal layer 40 disposed between the TFT substrate 10 and the counter substrate 20. The liquid crystal layer 40 contains liquid crystal molecules 41 which are aligned in parallel with the faces of the substrates 10 and 20. The TFT substrate 10 includes a support substrate, a TFT, a scanning signal line, a data signal line, a common electrode (second electrode), a pixel electrode (first electrode), an insulating film separating the common electrode and the pixel electrode into different layers, an alignment film, and the like. The counter substrate 20 includes a support substrate, a color filter, a black matrix, an alignment film, and the like. Polarizers are each attached to the surfaces, which are on the opposite sides to the liquid crystal layer, of the TFT substrate 10 and the counter substrate 20.

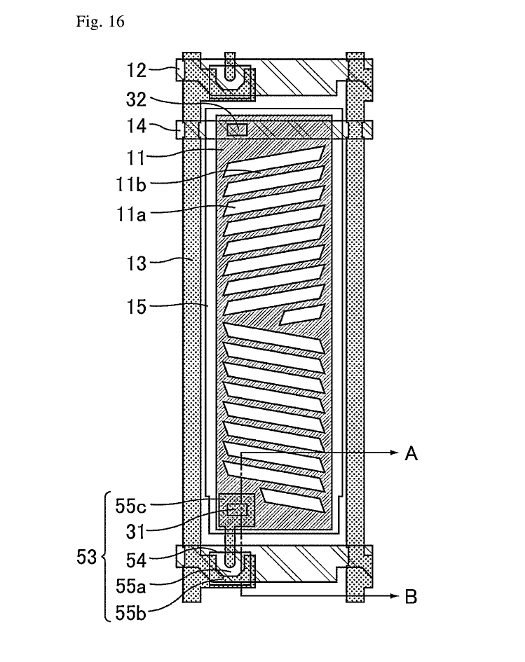

FIG. 16 is a schematic plan view illustrating the pixel structure of a TFT substrate of Embodiment 1. As shown in the plane view of the TFT substrate of Embodiment 1 in FIG. 16, scanning signal lines 12 and data signal lines 13 are disposed so that they cross each other and surround the pixel electrode 11. A thin film transistor (TFT) 53 is provided at the vicinity of a crosspoint of one of the scanning signal lines 12 and one of the data signal lines 13. A common signal line 14 extending in parallel with the scanning signal lines 12 is provided between the scanning signal lines 12. The common signal line 14 is connected to a common electrode 15 via a contact section 32 which penetrates an insulating film.

The TFT 53 is a switching element provided with a semiconductor layer 54, a gate electrode 55a, a source electrode 55b, and a drain electrode 55c. The gate electrode 55a consists of a portion of the scanning signal line 12. The source electrode 55b is a branch from the data signal line 13, and bends to surround the end of the drain electrode 55c. The drain electrode 55c is extended to the pixel electrode 11. The part of the drain electrode 55c over the pixel electrode 11 is wide and is connected to the pixel electrode 11 via a contact section 31 which penetrates an insulating film. The gate electrode 55a and the semiconductor layer 54 overlap each other with a gate insulator being interposed therebetween. The source electrode 55b is connected to the drain electrode 55c via the semiconductor layer 54. The amount of the current through the semiconductor layer 54 is controlled by a scanning signal fed through the scanning signal line 12 to the gate electrode. Thereby, transmission of a data signal fed through the data signal line 13 in the order of the source electrode 55b, the semiconductor layer 54, the drain electrode 55c, and the pixel electrode 11 is controlled.

The pixel electrodes 11 are comb teeth electrodes each disposed at a region surrounded by the scanning signal lines 12 and the data signal lines 13. Each pixel electrode 11 has a substantially rectangular outer rim and includes a plurality of slits 11a which allow the pixel electrode 11 to include a plurality of comb teeth 11b. The slits 11a and the comb teeth 11b extend at an angle of several degrees with respect to the direction in parallel with the longitudinal direction of the scanning signal lines 12. The plurality of slits 11a and the plurality of comb teeth 11b of the pixel electrode 11 each are symmetric to a boundary line which bisects a longitudinal side of the pixel electrode 11. Such a symmetric structure enables balanced alignment of the liquid crystal. An example of the pixel electrode 11 shown in FIG. 16 includes slits 11a having closed ends on both sides. The slits each may have an open end on one side and a closed end on the other side.

Embodiment 1 adopts a frame-inversion drive in which the polarity of a data signal supplied to the pixel electrodes 11 is inverted frame by frame. Thus, the liquid crystal material can be prevented from degrading. Depending on the need, aline inversion drive or a dot inversion drive may be adopted in which the polarity of a data signal supplied to the pixel electrodes 11 is inverted in a vertical direction or/and a horizontal direction of the adjacent pixel electrodes 11 in one frame. Such a data signal can be generated in a data signal line drive circuit.

The common electrode 15 has a flat plate shape. Unlike the pixel electrode, it does not include slits and thus does not include comb teeth. A constant common signal is supplied to the common electrode 15 through a common signal line 14. FIG. 16 shows an example where one common electrode 15 is formed in every region surrounded by the scanning signal lines 12 and the data signal lines 13. The section of one common electrode 15 is not necessarily defined as mentioned above. One common electrode 15 may be formed over a plurality of the above-mentioned regions as long as conduction routes of other wirings can surely be formed.

The structures of the electrode to which a data signal is supplied and the electrode to which a common signal is supplied may be opposite to the above-mentioned structures. For example, a pixel electrode may have a flat plate shape, whereas a common electrode may have at least two parallel comb teeth and at least two parallel slits.

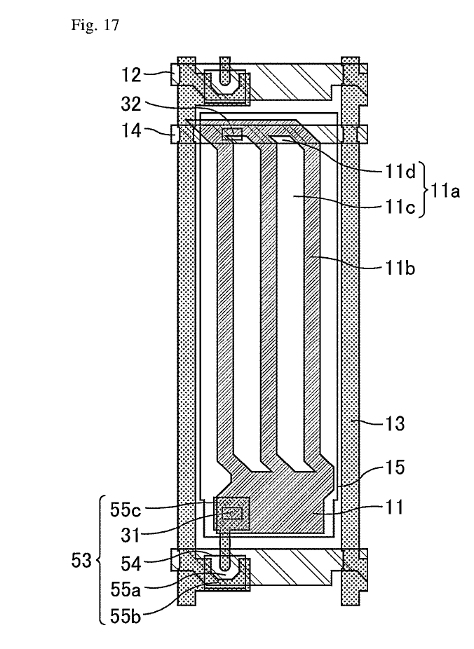

In the example of FIG. 16, the slits 11a in the pixel electrode 11 extend substantially in parallel with the scanning signal lines 12. As shown in FIG. 17, for example, the slits 11a in the pixel electrode 11 may extend substantially in parallel with the data signal lines 13. Moreover, the slits 11a in the pixel electrode 11 may have bent ends as shown in FIG. 17. That is, each slit 11a may consist of a linear portion 11c and a bent portion 11d which is tilted at a certain angle from the linear portion 11c. This structure can suppress disorder in the alignment of liquid crystals near the ends of the slits 11a.

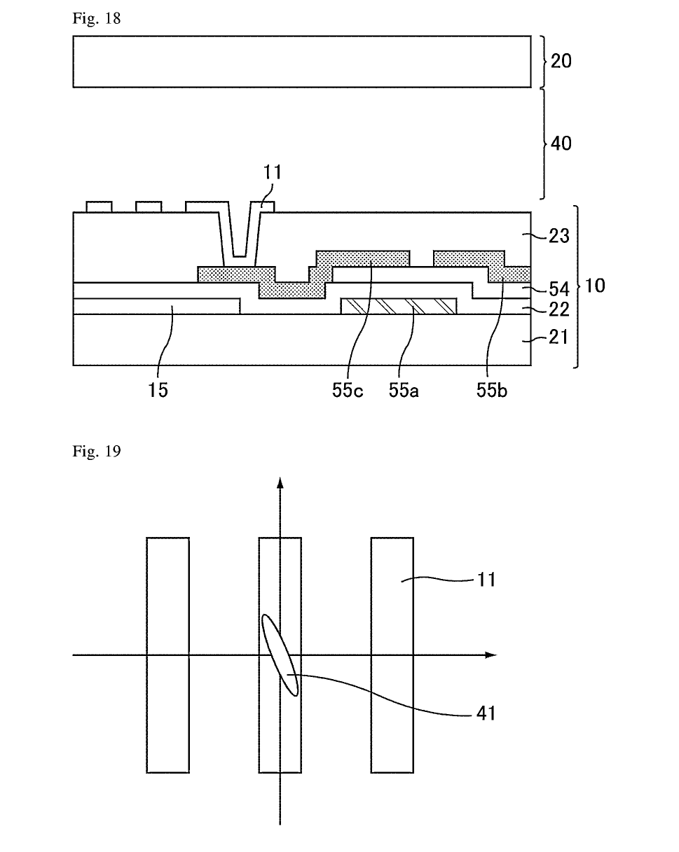

FIG. 18 is a schematic cross-sectional view of a liquid crystal display device of Embodiment 1. A TFT substrate 10 includes a support substrate 21 as a base. A common electrode 15, a gate electrode 55a, a gate insulator 22, a semiconductor layer 54, a source electrode 55b/a drain electrode 55c, a passivation film (PAS) 23, and a pixel electrode 11 are formed on the support substrate 21. A counter substrate 20 is further provided on the opposite side to the TFT substrate 10 across a liquid crystal layer 40. When a transverse electric field (arc-shaped electric field in a cross section) is generated in the liquid crystal layer 40 due to the potential difference between the common electrode 15 and the pixel electrode 11, the liquid crystal molecules change their directions, enabling a change in the birefringent light which passes through the liquid crystal layer 40.

FIG. 19 is an enlarged schematic plan view illustrating the vicinity of the comb teeth of the pixel electrode shown in FIG. 16. Assuming that a direction orthogonal to the longitudinal direction of the comb teeth of the pixel electrode 11 is a 0° direction, then, for example, the polarization axis of one of polarizers is disposed in a 5° direction, and the polarization axis of the other polarizer is disposed in a 95° direction. Moreover, alignment films of the TFT substrate 10 and the counter substrate 20 are subjected to an alignment treatment so that, for example, the major axes of liquid crystal molecules align in a 95° direction when no voltage is applied.

In the liquid crystal display device of Embodiment 1, a pixel electrode includes at least two slits having different widths from one another. At least two of the slits have a width of S1 and a width of S2. The pixel electrode includes at least two comb teeth having different widths from one another. At least two of the comb teeth have a width of L1 and a width of L2. The number of the comb teeth and the number of the slits in the pixel electrode are not particularly limited. The plurality of slits may further include, for example, a slit having a third width of S3 and a slit having a fourth width of S4, in addition to the two kinds of slits each having a width of S1 or S2. The pixel electrode may further include, for example, a comb tooth having a third width of L3 and a comb tooth having a fourth width of L4, in addition to the two kinds of comb teeth each having a width of L1 or L2.

In Embodiment 1, the widths of S1 and S2 of the slits and the widths of L1 and L2 of the comb teeth in the pixel electrode are designed to satisfy all the conditions (H1) to (H6′) below. It is sufficient if any two of the slits and any two of the comb teeth satisfy the following conditions. In the case where the number of the slits is three or more, the width of a slit with a minimum width is set as S1, and the width of a slit with a maximum width is set as S2. In the case where the number of comb teeth is three or more, the width of a comb tooth with a minimum width is set as L1, and the width of a comb tooth with a maximum width is set as L2.

S1/L2<W (H1)

Z<S2/L1 (H2)

1.27<W<1.60 (H3)

1.27<Z<1.60 (H4)

S1<S2 (H5′)

L1<L2 (H6′)

The above setting can achieve favorable display where flicker is rarely observed.

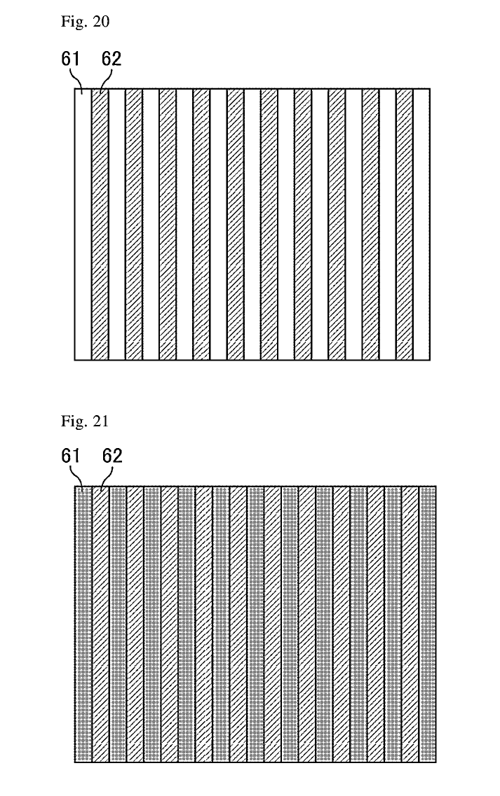

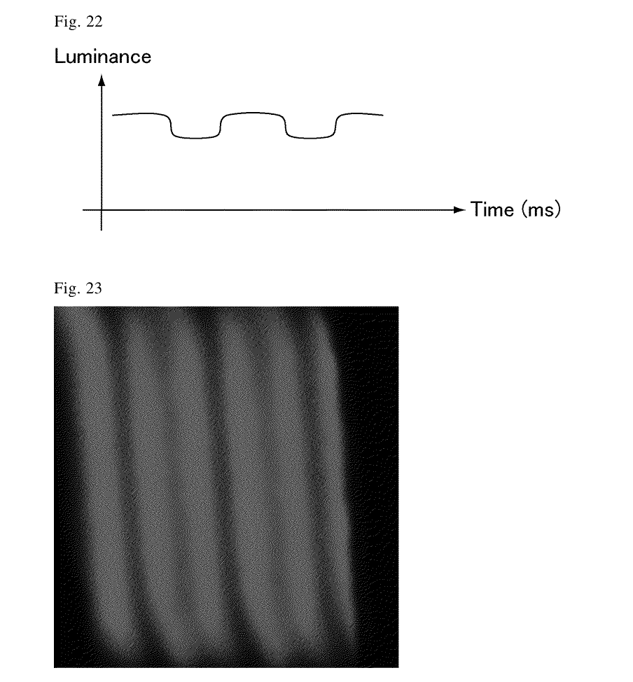

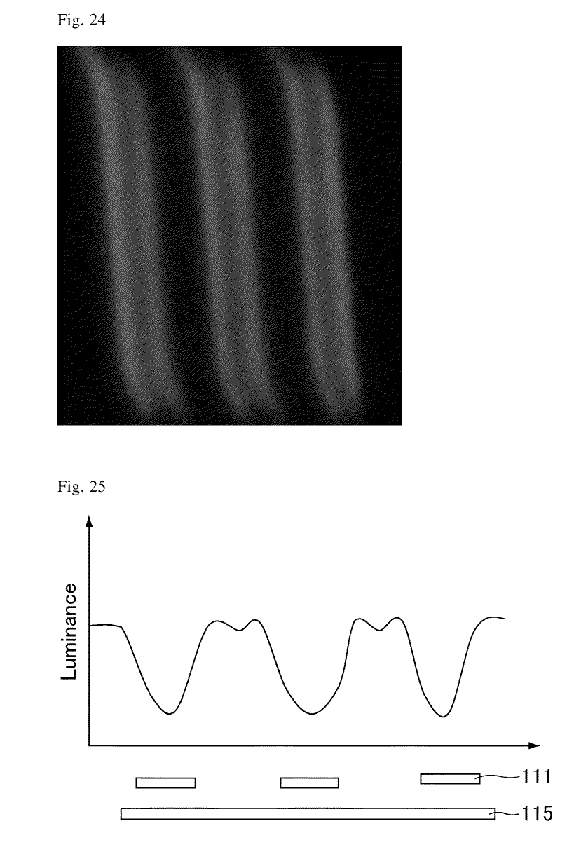

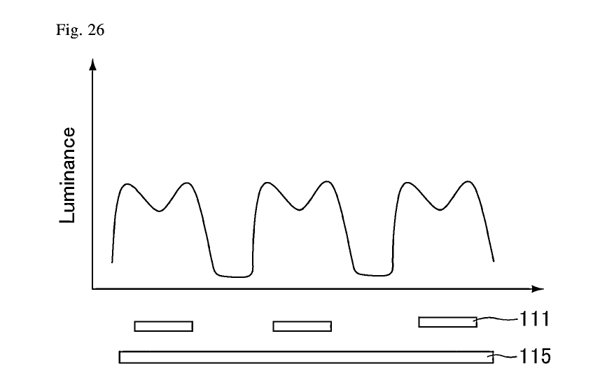

The following will describe one example of a method for measuring flicker. First, a display device is set to show a prescribed regular pattern on its screen for easy observation of flicker. For example, in the case of a source line (data signal line) inversion drive, a pattern as shown in FIG. 20 is formed. In the pattern, longitudinally extending lines 61 to which a positive voltage is applied and longitudinally extending lines 62 to which a negative voltage is applied are alternately provided. When the signal frequency is set to 60 Hz, the polarity of the voltage applied to the pixel electrodes is inverted 60 times per second. By blackening lines with either polarity (the lines 61 in FIG. 21) among the positive and negative lines 61 and 62, a waveform (luminance distribution) under positive polarity and a waveform (luminance distribution) under negative polarity can be recognized with time on the horizontal axis as shown in FIG. 22. The waveforms are different from each other due to flexoelectric polarization. A larger difference in the waveforms indicates a larger luminance ratio (=luminance under negative voltage application/luminance under positive voltage application), and thus flicker is visually observed more frequently.

In a practical measurement, the luminance can be measured, for example, by irradiating apart of a display screen from the back side thereof with light from a photodiode, and measuring the luminance using a luminance meter.

The following describes the materials and methods for producing the components.

The support substrate 21 is favorably formed of transparent materials such as glass and plastics. The gate insulator 22 and the passivation film 23 are favorably formed of transparent materials such as silicon nitride, silicon oxide, and photosensitive acrylic resin. For formation of the gate insulator 22 and the passivation film 23, for example, a silicon nitride film is formed by plasma enhanced chemical vapor deposition (PECVD), and then a photosensitive acrylic resin film is formed on the silicon nitride film by a die-coating (application) method. A hole provided in the gate insulator 22 or the passivation film 23 for formation of the contact portions 31 and 32 can be formed by dry etching (channel etching).

The scanning signal lines 12, the data signal lines 13, and various electrodes forming the TFT 53 can be produced, for example, by forming a single layer or multiple layers of a metal such as titanium, chromium, aluminum, or molybdenum, or an alloy thereof by sputtering or the like, and subsequently performing patterning by photolithography or the like. These lines and electrodes to be formed on the same layer are formed from the same materials so as to achieve efficient production.

The semiconductor layer 54 of the TFT 53 may be, for example, a stack of a high-resistance semiconductor layer (i layer) formed of amorphous silicon, poly silicon, or the like and a low-resistance semiconductor layer (n⁺ layer) formed of n⁺amorphous silicon which is prepared by doping amorphous silicon with impurities such as phosphor. An oxide semiconductor, such as IGZO (indium-gallium-zinc-oxygen), may also be preferably used as the semiconductor layer 54. Detailed description thereof will be provided below.

Use of an oxide semiconductor, such as IGZO, as a material of the semiconductor layer 54 is advantageous mainly for the following two reasons: (i) the high electron mobility of an oxide semiconductor allows for a smaller TFT, and thus the aperture ratio can be increased; and (ii) the electric charge can be kept for a long time due to the low off-current leakage characteristics, thereby allowing for a low frequency drive.

In view of the above (ii) in particular, an oxide semiconductor, such as IGZO, is preferably used as a material of the semiconductor layer 54 in the present invention for the following reason. Flicker is likely to be visible in an FFS mode due to flexoelectric polarization and is more visible when an image signal has a low frequency. In contrast, since flicker due to flexoelectric polarization is suppressed in the present invention, flicker is less visible even in a low frequency drive. Thus, a low frequency drive may be employed. An embodiment using an oxide semiconductor, such as IGZO, is suited for the present invention.

An oxide semiconductor layer (active layer) 54 of an active drive element (TFT) is formed as follows. First, an In—Ga—Zn—O semiconductor film (hereinafter, also referred to as IGZO film) with a thickness of 30 nm or greater but 300 nm or smaller is formed on an insulating film 22 by sputtering. Then, a resist mask is formed by photolithography so as to cover predetermined regions of the IGZO film. Next, portions of the IGZO film other than the regions covered by the resist mask are removed by wet etching. Thereafter, the resist mask is peeled off. This provides island-shaped oxide semiconductor layer 54. The oxide semiconductor layer 54 may be formed using other oxide semiconductor films instead of the IGZO film. Examples of the other oxide semiconductor include Zn—O-based (ZnO) semiconductors, In—Zn—O-based (IZO) semiconductors, and Zn—Ti—O-based (ZTO) semiconductors. Next, a passivation film 23 is deposited on the whole surface, and the passivation film 23 is patterned. Specifically, for example, an SiO₂ film (thickness: about 150 nm) as a passivation film 23 is formed on the gate insulator 22 and the oxide semiconductor layer 54 by CVD. The passivation film 23 preferably includes an oxide film such as a SiOy film. Use of an oxide film can recover oxygen deficiency on the oxide semiconductor layer 54 by the oxygen in the oxide film, and thus it more effectively suppresses oxygen deficiency on the oxide semiconductor layer 54. Here, a single layer of an SiO₂ film may be used as the passivation film 23, or the passivation film 23 may have a stacked structure of an SiO₂ film as a lower layer and an SiNx film as an upper layer. The thickness (in the case of a stacked structure, the sum of the thicknesses of the layers) of the passivation film 23 is preferably 50 nm or greater but 200 nm or smaller. The passivation film 23 with a thickness of 50 nm or greater more surely protects the surfaces of the oxide semiconductor layer 54 in the step of patterning the source electrode 55b or drain electrode 55c. If the thickness of the passivation film 23 exceeds 200 nm, the source electrode 55b or the drain electrode 55c may have a higher step, so that breaking of lines may occur.

For formation of the pixel electrode 11 and the common electrode 15, for example, a transparent conductive material (e.g., indium tin oxide (ITO), indium zinc oxide (IZO), zinc oxide (ZnO), tin oxide (SnO)) or an alloy thereof may be deposited by sputtering or the like to form a mono- or multi-layer film, and then patterning is performed by photolithography, or the like. The slits formed in the pixel electrode 11 can be formed simultaneously with the patterning.

For formation of the color filter, photosensitive resins (color resists) which transmit light corresponding to the respective filter colors are preferably used. The material of the black matrix is not particularly limited as long as it blocks light. Resin materials containing black pigments or light-blocking metallic materials are preferably used.

The thus formed TFT substrate 10 and counter substrate 20 are bonded to each other using a sealing material after plural cylindrical spacers formed of an insulating material are provided on one of the substrates. A liquid crystal layer 40 is formed between the TFT substrate 10 and the counter substrate 20. In the case of dropwise addition for formation of the liquid crystal layer 40, liquid crystal materials are dripped before the substrates are bonded to each other. In the case of a vacuum injection method, liquid crystal materials are injected after the substrates are bonded to each other. Then, a polarizer, a retardation film, or the like are attached to the surface of each substrate not facing the liquid crystal layer 40. Thus, a liquid crystal display device is produced. Moreover, a liquid crystal display device may be equipped with a gate driver, a source driver, and a display control circuit and the like, and combined with a back light unit or the like, thereby providing a liquid crystal display device suitable for an intended application.

### Embodiment 2

A liquid crystal display device of Embodiment 2 is substantially the same as that of Embodiment 1, except that the setting of the width of the comb teeth and the width of the slits of the pixel electrode is different. Specifically, the width of the comb teeth of the pixel electrode is fixed to L in Embodiment 2. The slits of the pixel electrode include at least two slits having different widths from one another, and at least two of the slits have a width of S1 and a width of S2. The number of the comb teeth of the pixel electrode and the number of the slits of the pixel electrode are not particularly limited. The plurality of comb teeth of the pixel electrode are not limited to the two kinds of slits each having a width of S1 or S2 but may include, for example, slits having a third width of S3 and a fourth width of S4.

In Embodiment 2, the widths of S1 and S2 of the slits and the width of L of the comb teeth of the pixel electrode are designed to basically satisfy the conditions of the formulas (H1) to (H4) and further satisfy the conditions of the following formulas (A1) to (A4). It is sufficient if any two of the plurality of slits satisfy the following conditions. In the case where three or more slits have different widths from one another, the width of a slit having a minimum width is set as S1, and the width of a slit having a maximum width is set as S2.

1.07<S1/L2<1.58 (A1)

1.33<S2/L1<1.83 (A2)

S1<S2 (A3)

L1=L2(=L) (A4)

In Embodiment 2, any one or all of the conditions of the following formula (A5) to (A12) are preferably satisfied.

L≦4.5 μm (A5)

2.0 μm≦L (A6)

3.5 μm≦S1 (A7)

S2≦7.5 μm (A8)

S1<4.5 μm (A9)

4.5 μm<S2 (A10)

S1<5.5 μm (A11)

5.5 μm<S2 (A12)

### Embodiment 3

A liquid crystal display device of Embodiment 3 is substantially the same as that of Embodiment 1, except that the setting of the width of the comb teeth and the width of the slits of the pixel electrode is different. Specifically, the width of the comb teeth of the pixel electrode is fixed to L in Embodiment 3. The slits of the pixel electrode include at least two slits having different widths from one another, and at least two of the slits have a width of S1 and a width of S2. The number of the comb teeth of the pixel electrode and the number of the slits of the pixel electrode are not particularly limited. The plurality of comb teeth of the pixel electrode are not limited to the two kinds of slits each having a width of S1 or S2 but may include, for example, slits having a third width of S3 and a fourth width of S4.

In Embodiment 3, the widths of S1 and S2 of the slits and the width of L of the comb teeth of the pixel electrode are designed to basically satisfy the conditions of the formulas (H1) to (H4) and further satisfy the conditions of the following formulas (B1) to (B8). It is sufficient if any two of the plurality of slits satisfy the following conditions. In the case where three or more slits have different widths from one another, the width of a slit having a minimum width is set as S1, and the width of a slit having a maximum width is set as S2.

Y=aX²+bX+c (B1)

Y=S1/L2 (B2)

X=S2/L1 (B3)

S1<S2 (B4)

L1=L2(=L) (B5)

0.50≦a≦0.64 (B6)

−2.40≦b≦−1.86 (B7)

2.78≦c≦3.52 (B8)

In Embodiment 3, any one or all of the conditions of the following formula (B9) to (B16) are preferably satisfied.

L≦4.5 μm (B9)

2.0 μm≦L (B10)

3.5 μm≦S1 (B11)

S2≦7.5 μm (B12)

S1<4.5 μm (B13)

4.5 μm<S2 (B14)

S1<5.5 μm (B15)

5.5 μm<S2 (B16)

### Embodiment 4

A liquid crystal display device of Embodiment 4 is substantially the same as that of Embodiment 1, except that the setting of the width of the comb teeth and the width of the slits of the pixel electrode is different. Specifically, the width of the slits of the pixel electrode is fixed to S in Embodiment 4. The comb teeth of the pixel electrode include at least two comb teeth having at least different widths from one another, and at least two of the comb teeth have a width of L1 and a width of L2. The number of the comb teeth of the pixel electrode and the number of the slits of the pixel electrode are not particularly limited. The plurality of comb teeth of the pixel electrode are not limited to the two kinds of comb teeth each having a width of L1 or L2 but may include, for example, comb teeth having a third width of L3 and a fourth width of L4.

In Embodiment 4, the widths of L1 and L2 of the comb teeth and the width of S of the slits of the pixel electrode are designed to basically satisfy the conditions of the formulas (H1) to (H4) and further satisfy the conditions of the following formulas (C1) to (C4). It is sufficient if any two of the plurality of comb teeth satisfy the following conditions. In the case where three or more comb teeth have different widths from one another, the width of a comb tooth having a minimum width is set as L1, and the width of a comb tooth having a maximum width is set as L2.

0.92<S1/L2<1.44 (C1)

1.31<S2/L1<1.84 (C2)

L1<L2 (C3)

S1=S2(=S) (C4)

In Embodiment 4, any one or all of the conditions of the following formula (C5) to (C12) are preferably satisfied.

S≦5.6 μm (C5)

2.0 μm≦S (C6)

2.5 μm≦L1 (C7)

L2≦7.5 μm (C8)

L1<3.7 μm (C9)

3.7 μm<L2 (C10)

L1<4.5 μm (C11)

4.5 μm<L2 (C12)

### Embodiment 5

A liquid crystal display device of Embodiment 5 is substantially the same as that of Embodiment 1, except that the setting of the width of the comb teeth and the width of the slits of the pixel electrode is different. Specifically, the width of the slits of the pixel electrode is fixed to S in Embodiment 5. The comb teeth of the pixel electrode include at least two comb teeth having at least different widths from one another, and at least two of the comb teeth have a width of L1 and a width of L2. The number of the comb teeth of the pixel electrode and the number of the slits of the pixel electrode are not particularly limited. The plurality of comb teeth of the pixel electrode are not limited to the two kinds of comb teeth each having a width of L1 or L2 but may include, for example, comb teeth having a third width of L3 and a fourth width of L4.

In Embodiment 5, the widths of S1 and S2 of the slits and the width of L of the comb teeth of the pixel electrode are designed to basically satisfy the conditions of the formulas (1-11) to (1-14) and further satisfy the conditions of the following formulas (D1) to (D8). It is sufficient if any two of the plurality of comb teeth satisfy the following conditions. In the case where three or more comb teeth have different widths from one another, the width of a comb tooth having a minimum width is set as L1, and the width of a comb tooth having a maximum width is set as L2.

Y=aX²+bX+c (D1)

Y=S1/L2 (D2)

X=S2/L1 (D3)

L1<L2 (D4)

S1=S2(=S) (D5)

7.6≦a≦16.0 (D6)

−22.5≦b≦−13.1 (D7)

6.35≦c≦8.55 (D8)

In Embodiment 5, any one or all of the conditions of the following formulas (D9) to (D16) are preferably satisfied.

S≦5.6 μm (D9)

2.0 μm≦S (D10)

2.5 μm≦L1 (D11)

L2≦7.5 μm (D12)

L1<3.7 μm (D13)

3.7 μm<L2 (D14)

L1<4.5 μm (D15)

4.5 μm<L2 (D16)

### Embodiment 6

A liquid crystal display device of Embodiment 6 is substantially the same as that of Embodiment 1, except that the setting of the width of the comb teeth and the width of the slits of the pixel electrode is different. Specifically, the slits of the pixel electrode include at least two slits having different widths from one another, and at least two of the slits have a width of S1 and a width of S2. The comb teeth of the pixel electrode include at least two comb teeth having at least different widths from one another, and at least two of the comb teeth have a width of L1 and a width of L2. The number of the comb teeth of the pixel electrode and the number of the slits of the pixel electrode are not particularly limited. The plurality of slits of the pixel electrode are not limited to the two kinds of slits each having a width of S1 or S2 but may include, for example, slits having a third width of S3 and a fourth width of S4. The plurality of comb teeth of the pixel electrode are not limited to the two kinds of comb teeth each having a width of L1 or L2 but may include, for example, comb teeth having a third width of L3 and a fourth width of L4.

In Embodiment 6, the widths of S1 and S2 of the slits and the widths of L1 and L2 of the comb teeth of the pixel electrode are designed to basically satisfy the conditions of the formulas (H1) to (H4) and further satisfy all the conditions of the following formulas (E1) to (E4′). It is sufficient if any two of the plurality of slits satisfy the following conditions, and any two of the plurality of comb teeth satisfy the following conditions. In the case where three or more slits have different widths from one another, the width of a slit having a minimum width is set as S1, and the width of a slit having a maximum width is set as S2. In the case where three or more comb teeth have different widths from one another, the width of a comb tooth having a minimum width is set as L1, and the width of a comb tooth having a maximum width is set as L2.

0.92<S1/L2<1.58 (E1)

1.31<S2/L1<1.84 (E2)

S1<S2 (E3′)

L1<L2 (E4′)

In Embodiment 6, any one or all of the conditions of the following formula (E5) to (E8) are preferably satisfied.

2.0 μm≦S1≦5.6 μm (E5)

2.0 μm≦S2≦7.5 μm (E6)

2.0 μm≦L1≦4.5 μm (E7)

2.0 μm≦L2≦7.5 μm (E8)

### REFERENCE SIGNS LIST

10: TFT substrate
11, 111: Pixel electrode
11a: Slit
11b: Comb tooth
11c: Linear portion of a slit
11d: Bent portion of a slit
12: Scanning signal line
13: Data signal line
14: Common signal line
15, 115: Common electrode
20: Counter substrate
21: Support substrate
22: Gate insulator
23: Passivation film
31, 32: Contact section
40: Liquid crystal layer
41: Liquid crystal molecules
53: TFT
54: Semiconductor layer
55a: Gate electrode
55b: Source electrode
55c: Drain electrode
61: Line to which a positive voltage is applied
62: Line to which a negative voltage is applied

1. A liquid crystal display device comprising:
a pair of substrates; and
a liquid crystal layer interposed between the pair of substrates, at least one of the pair of substrates comprising a first electrode that includes at least two parallel comb teeth and at least two parallel slits, a second plate electrode, and an insulating film that separates the first electrode and the second electrode into different layers,
assuming that the width of a comb tooth is L1 and the width of another comb tooth is L2 among the at least two comb teeth; and that the width of a slit is S1 and the width of another slit is S2 among the at least two slits, then L1, L2, S1, and S2 satisfy the following formulas (H1) to (H6):
S1/L2<W (H1)
Z<S2/L1 (H2)
1.27<W<1.60 (H3)
1.27<Z<1.60 (H4)
S1≦S2 (H5)
L1≦L2 (H6)
provided that S1 and L1 are not simultaneously equal to S2 and L2, respectively; when the at least two slits include three or more slits having different widths, S1 is set as the minimum width, and S2 is set as the maximum width; and when the at least two comb teeth include three or more comb teeth having different widths, L1 is set as the minimum width, and L2 is set as the maximum width.

2. The liquid crystal display device according to claim 1,
wherein L1, L2, S1, and S2 satisfy the following formulas (F1) to (F6):
S1/L2<W (F1)
Z<S2/L1 (F2)
1.27<W<1.45 (F3)
1.27<Z<1.45 (F4)
S1<S2 (F5)
L1=L2 (F6).

3. The liquid crystal display device according to claim 1,
wherein L1, L2, S1, and S2 satisfy the following formulas (G1) to (G6):
S1/L2<W (G1)
Z<S2/L1 (G2)
1.28<W<1.60 (G3)
1.28<Z<1.60 (G4)
S1=S2 (G5)
L1<L2 (G6).

4. The liquid crystal display device according to claim 1,
wherein L1, L2, S1, and S2 satisfy the following formulas (E1) to (E4):
0.92<S1/L2<1.58 (E1)
1.31<S2/L1<1.84 (E2)
S1≦S2 (E3)
L1≦L2 (E4)
provided that S1 and L1 are not simultaneously equal to S2 and L2, respectively.

5. The liquid crystal display device according to claim 4, wherein L1, L2, S1, and S2 satisfy the following formulas (A1) to (A4):
1.07<S1/L2<1.58 (A1)
1.33<S2/L1<1.83 (A2)
S1<S2 (A3)
L1=L2 (A4).

6. The liquid crystal display device according to claim 4,
wherein L1, L2, S1, and S2 satisfy the following formulas (B1) to (B8):
Y=aX²+bX+c (B1)
Y=S1/L2 (B2)
X=S2/L1 (B3)
S1<S2 (B4)
L1=L2 (B5)
0.50≦a≦0.64 (B6)
−2.40≦b≦−1.86 (B7)
2.78≦c≦3.52 (B8).

7. The liquid crystal display device according to claim 4,
wherein L1, L2, S1, and S2 satisfy the following formulas (C1) to (C4):
0.92<S1/L2<1.44 (C1)
1.31<S2/L1<1.84 (C2)
L1<L2 (C3)
S1=S2 (C4).

8. The liquid crystal display device according to claim 4,
wherein L1, L2, S1, and S2 satisfy the following formulas (D1) to (D8):
Y=aX²+bX+c (D1)
Y=S1/L2 (D2)
X=S2/L1 (D3)
L1<L2 (D4)
S1=S2 (D5)
7.6≦a≦16.0 (D6)
−22.5≦b≦−13.1 (D7)
6.35≦c≦8.55 (D8).

9. The liquid crystal display device according to claim 1, further comprising a thin film transistor, the thin film transistor comprising a semiconductor layer that includes an oxide semiconductor.
